(19) United States
(12) Patent Application Publication
(10) Pub. No.: US 2026/0257092 A1
(43) Pub. Date: Sep. 3, 2026

(54) SYSTEM FOR TEMPORARY INSTALLATION OF MODULAR FIRE SPRINKLERS

(71) Applicant: Jeremy Souza, Swansea, MA (US)

(72) Inventor: Jeremy Souza, Swansea, MA (US)

(21) Appl. No.: 19/442,300

(22) Filed: Jan. 7, 2026

Related U.S. Application Data
(60) Provisional application No. 63/765,107, filed on Feb. 28, 2025.

(51) Int. Cl. A62C 35/68

(52) U.S. Cl. CPC A62C 35/68

(57) ABSTRACT

The present invention relates to a system for temporary installation of modular sprinklers. The system comprises a water source, hoses, and modular sprinkler connectors. The hoses connect the water source to the connectors. The hoses further connect the connectors to other connectors in a line, loop, tree, or grid pattern. The integrated system of hoses and connectors are attached to the ceiling using brackets and fasteners to allow for ease of assembly, movement, relocation, and disassembly. The system allows for an efficient and effective system to temporarily install a fire sprinkler system for use in initial construction, alteration, or reconstruction of large wood frame or other buildings.

### CROSS-REFERENCE TO RELATED APPLICATIONS

This non-provisional application claims the benefit of priority to U.S. Provisional Application No. 63/765,107, filed Feb. 28, 2025, the entire contents of which are incorporated by reference herein.

### STATEMENT REGARDING FEDERALLY SPONSORED RESEARCH

N/A

### NAMES OF PARTIES TO A JOINT RESEARCH AGREEMENT

N/A

### INCORPORATION BY REFERENCE STATEMENT: COMPUTER PROGRAM, SEQUENCE LISTING, OR LARGE TABLES

N/A

### STATEMENT OF PRIOR DISCLOSURES

N/A

### BACKGROUND OF THE INVENTION

### Field of Invention

The invention relates generally to a temporary fire protection system. In particular, the present invention is a temporary system installed for fire protection comprising a water source, modular sprinkler connectors, and hoses. The present invention would allow for the installation of a quick, reliable, and efficient temporary system of modular fire sprinklers for use during initial construction, alteration, demolition, or reconstruction of large wood frame buildings and other buildings that are traditionally provided with sprinkler protection.

### Brief Review of Related Art

The present invention relates generally to a temporary system installed for fire protection during initial construction, alteration, demolition, or reconstruction of large wood frame buildings. According to the Federal Emergency Management Agency (FEMA) and National Fire Protection Association (NFPA), an estimated 4,800 construction site fires occur each year amounting to approximately $370 million in property loss, five civilian deaths, and 59 civilian injuries. In addition to property damage, firefighter personnel are also injured. In fact, these personnel are more likely to be struck by debris and other objects while fighting these fires than at other fire sites.

The most recent edition of the consensus standard regulating fire safety during initial construction, NFPA 241 Standard for Safeguarding Construction, Alteration, and Demolition Operations (2022) (NFPA), strongly encourages water-based fire protection or fast-tracking installation of the building's fire sprinkler system during construction. Additionally, builders are required by risk insurers to install sprinkler protection during construction.

Construction increases the complexity of proper fire protection systems, such as fire sprinkler systems, for several reasons. Installing hard pipe systems first requires the subsequent removal and reinstallation of the permanent system after construction is complete. This is time consuming, costly, and impractical. Additionally, the sprinklers are not generally located in a manner required for adequate fire protection. As such, this method requires frequent modifications by sprinkler fitters or plumbers. Sprinkler installation may be fast-tracked as well. However, with this option, the sequence of installation of mechanical, electrical, and plumbing components is changed, complicating the construction process by adding time, cost, and material required for completion. By installing hard pipe systems first or fast-tracking fire sprinkler systems, time is wasted, costs increase, and more material is required to complete construction, consuming time, manpower, and resources, making these option impractical. In fact, the current approaches for fire protection during construction discourage sprinkler protection in the majority of spaces due to high cost.

Thus, the present invention solves these problems because the temporary system installed for fire protection can be easily set-up, moved, relocated, disassembled, and reassembled during the construction process. The present invention includes fire hoses which are easily moved or relocated. Additionally, the present invention includes modular sprinkler connectors which are easily moved or relocated. As this system is easily set-up, moved, relocated, disassembled, and reassembled, the system reduces cost, time, and material. The system also properly locates the sprinkler head for efficient firefighting capability and protection of the sprinkler during construction or alterations. The system may be moved in order for permanent equipment to be placed in the correct location. Further, as this is a temporary system, the permanent fire sprinkler system may be installed at a later time to allow for the sprinklers to be installed in an adequate manner. The present invention simplifies the construction process by reducing time, cost, and use of materials. Further, the present invention simplifies the construction process by installing a temporary, flexible, modular system which is quickly and easily installed and repositioned.

### BRIEF SUMMARY OF THE INVENTION

The present invention discloses a system for temporary installation of modular fire sprinklers. In particular, the present invention is a system for temporary fire protection comprising a water source, fire hoses, and modular sprinkler connectors. The water source may be any water source, such as a water tower, city water, well, temporary water storage, or any storage container providing adequate amounts of water and pressure for fire protection. The fire hoses may be any kind of well-known fire hose, such as, for example, hoses from 1 inch in diameter to 6 inches in diameter. However, the present invention may include any sized hose that is sufficient to provide fire suppression through sprinklers. For example, a fire hose with a 2-inch diameter may be used. The modular sprinkler connector may be a straight connector, a tee connector, or a cross connector, or any other shaped connector. The modular sprinkler connector further comprises the sprinkler head. A water source is connected to this system using fire hoses. The fire hoses attach on one side to the water source and to the modular sprinkler connector on the other end. Additionally, the fire hoses are connected on one side to a modular sprinkler connector and on the other end to an additional modular sprinkler connector or an end cap at the end of the line. The hoses and modular sprinkler connectors are attached to the ceiling using mounting brackets and fasteners. In this way, the system may be set up in several ways, such as a line, loop, tree, grid, or other sufficient means to properly cover a space with a fire sprinkler system.

In one preferred embodiment, the system comprises: (a) a water source to supply water to a location; (b) hoses to connect said water source to modular sprinkler connectors and to connect modular sprinkler connectors to other modular sprinkler connectors; and (c) modular sprinkler apparatus at a location designating a configuration to provide fire suppression coverage of a building.

In some aspects, the water source provided for to supply water is selected from one or more of the following sources: water tower, water tank, portable water supply, fire pump, city water, fire hydrant, standpipe, existing fire protection system, lake, pond, river, stream, ocean, or any other body of water suitable as a source, or any storage container providing adequate amounts of water and pressure for fire suppression.

In some aspects, the fire hoses are standard hoses of any suitable length, preferably 12 feet in length, and any suitable diameter, preferably 2 inches in diameter with 1-½ inch nominal fire hose threads.

In one embodiment, the modular sprinkler apparatus is a straight connector modular fire sprinkler apparatus further comprising a hexagonal or round body, threaded ends, brackets, a sprinkler, an open-ended pipe, and a fastening hole.

In another embodiment, the modular sprinkler apparatus is a tee connector modular fire sprinkler apparatus further comprising a hexagonal or round body, threaded ends, brackets, a sprinkler, an open-ended pipe, and a fastening hole.

In another embodiment, the modular sprinkler apparatus is a cross connector modular fire sprinkler apparatus further comprising a hexagonal or round body, threaded ends, brackets, a sprinkler, an open-ended pipe, and a fastening hole.

In some aspects, the configuration of the modular sprinkler apparatus at a location is configured in a pattern selected from one or more of the following patterns: straight, loop, tree, and grid.

### BRIEF DESCRIPTION OF THE DRAWINGS

The present invention relates generally to a system for temporary installation of modular fire sprinklers. The novel features that are characteristic of the present invention are set forth in the appended claims. However, the preferred embodiments of the invention, together with further objects and advantages, are better understood by reference to the following detailed description read concurrently with the accompanying drawings in which:

FIG. 1 is a perspective view of the straight connector modular fire sprinkler apparatus 100 including a hexagonal body 110, threaded ends 116, brackets 112, and a sprinkler 120, and further including an open-ended pipe 118 surrounded by the threaded end.

FIG. 2 is an exploded view of the straight connector modular fire sprinkler apparatus 100, including the hexagonal body 110, threaded ends 116, brackets 112, and sprinkler 120, and further including an open-ended pipe 118 surrounded by the threaded end.

FIG. 3 is a perspective view of the tee connector modular fire sprinkler apparatus 200 including the hexagonal body 210, threaded ends 216, brackets 212, and sprinkler 220, and further including an open-ended pipe 218 surrounded by the threaded end.

FIG. 4 is a perspective view of the cross connector modular fire sprinkler apparatus 300 including the hexagonal body 310, threaded ends 316, brackets 312, and sprinkler 320, and further including an open-ended pipe 318 surrounded by the threaded end.

FIG. 5 is a perspective overview of the system for temporary installation of modular fire sprinklers wherein a straight connector 100, tee connector 200, and cross-connector 300 are connected by fire hoses.

### DETAILED DESCRIPTION OF THE INVENTION

The present invention discloses a system for temporary installation of modular fire sprinklers comprising a water source, fire hoses, and modular sprinkler connectors.

### Definitions

The terms defined herein should be understood to control over dictionary definitions or the ordinary meaning of the terms:

The term “straight connector modular fire sprinkler apparatus” refers to one aspect of the present invention wherein the apparatus is shaped in a straight line with two ends and comprises one inlet and one outlet and wherein water provided by a source flows straight.

The term “tee connector modular fire sprinkler apparatus” refers to one aspect of the present invention wherein the apparatus is tee shaped with three ends and wherein water provided by a source flows in one inlet and out two outlets.

The term “cross connector modular fire sprinkler apparatus” refers to one aspect of the present invention wherein the apparatus is cross shaped with four ends and wherein water provided by a source flows in one inlet and out three outlets.

The term “loop” refers to a configuration wherein hoses connect modular sprinkler apparatus in a circular pattern.

The term “tree” refers to a configuration wherein hoses connect modular sprinkler apparatus on a straight line with additional modular sprinkler apparatus connected to this straight line pattern.

The term “grid” refers to a configuration wherein hoses connect modular sprinkler apparatus in a square pattern.

### Modular Fire Sprinkler Device

The present invention relates generally to a system for temporary installation of modular fire sprinklers for use during initial construction, alteration, and reconstruction of large wood frame or other buildings. The following is a description of one of the components of the system.

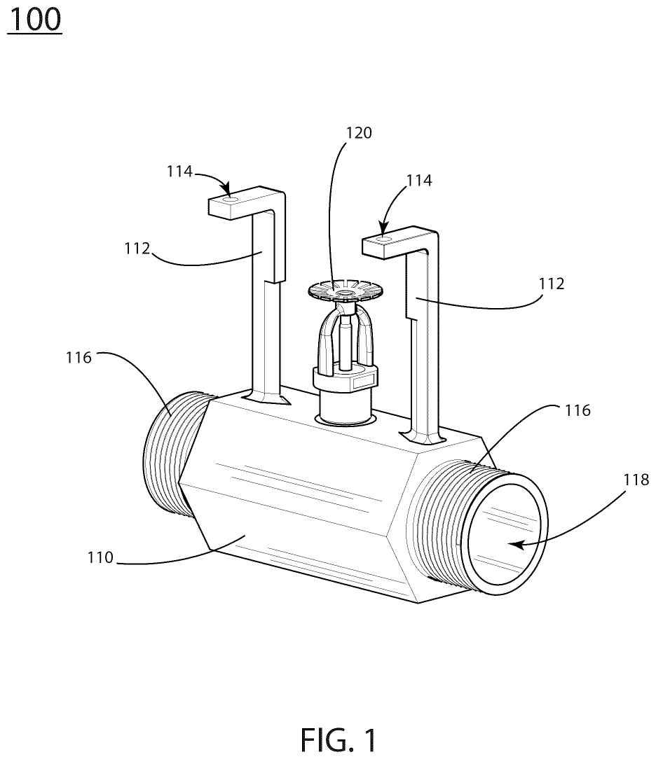

FIG. 1 illustrates a perspective view of the straight connector modular fire sprinkler apparatus 100. This figure comprises a hexagonal main body 110, two male threaded ends 116, two brackets 112, and a sprinkler 120. The main body 110 comprises an outer hexagonal shape and open-ended pipe 118 on the inside. On each end of the modular fire sprinkler there is a male threaded fitting 116 which connects to a female threaded fitting on a fire hose. The modular fire sprinkler apparatus 110 further comprises two L-shaped brackets 112 with a vertical plane and horizontal plane. The vertical plane of the L-shaped brackets 112 attaches to an outside face of the main body 110. From this attachment, the vertical planes extend perpendicular away from the main body 110. At a distance, the L-shaped bracket 112 bends at a right angle to form the horizontal plane of the L-shaped bracket 112. The horizontal plane further comprises a fastening hole 114 for inserting a fastener. The vertical plane of the L-shaped bracket 112 is tapered along the edge nearest to the sprinkler head 120 to reduce obstruction to water spray distribution from the sprinkler.

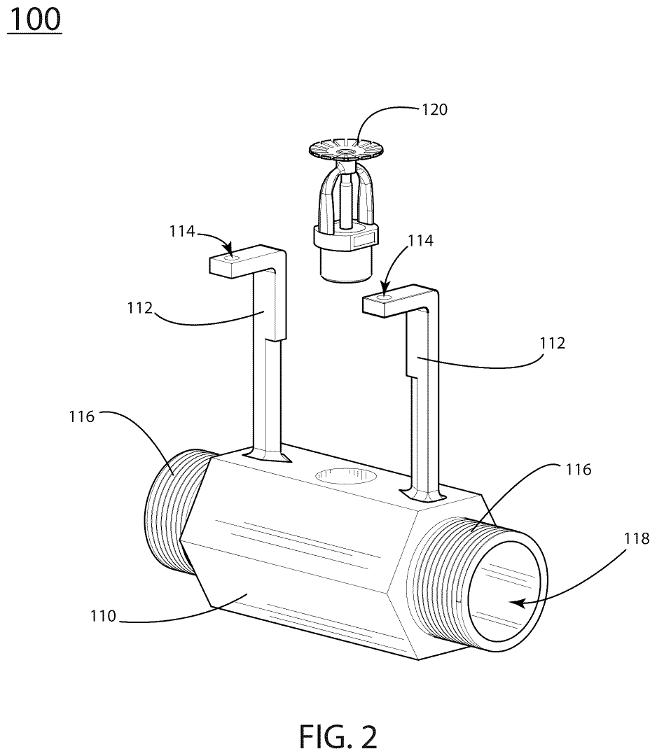

FIG. 2 is an exploded view of the straight connector modular fire sprinkler apparatus 100 including the hexagonal body 110, threaded end 116, brackets 112, and sprinkler 120. This figure illustrates a hexagonal main body 110, male threaded ends 116, two brackets 112, and a sprinkler 120. The main body 110 comprises an outer hexagonal shape and open-ended pipe 118 on the inside. On both ends of the modular fire sprinkler there is a male threaded fitting 116. The sprinkler is shown in this exploded view to illustrate the means whereby the sprinkler 120 connects to the main body 110. The straight connector modular fire sprinkler apparatus 100 further comprises two L-shaped brackets 112 with a vertical plane and horizontal plane. The vertical plane of the L-shaped brackets 112 attaches to an outside face of the main body 110. From this attachment, the vertical plane of the L-shaped bracket 112 extends perpendicular away from the main body 110. At a distance, the L-shaped bracket 112 bends at a right angle to form the horizontal plane of the L-shaped bracket 112. The horizontal plane further comprises a fastening hole 114 for inserting a fastener. The vertical plane of the L-shaped bracket 112 is tapered along the edge nearest to the sprinkler 120 to reduce obstruction to water spray distribution from the sprinkler.

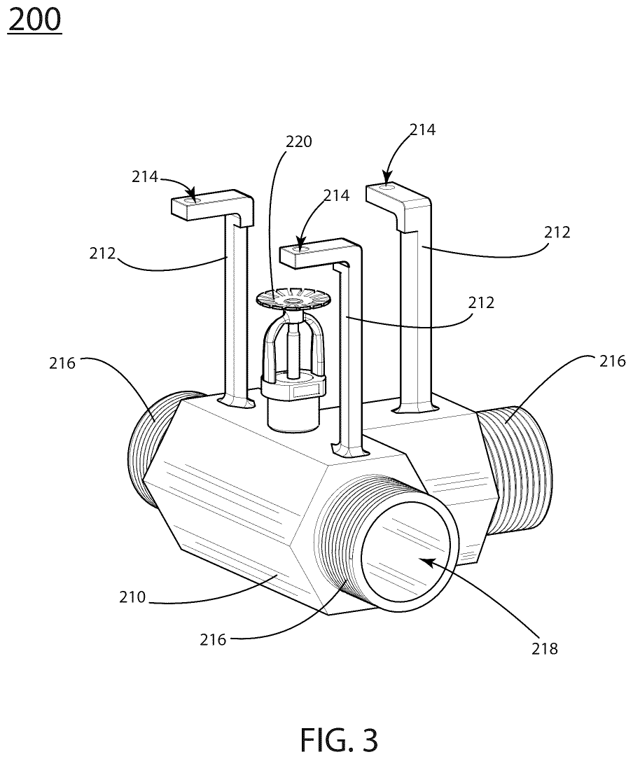

FIG. 3 illustrates a perspective view of a tee connector embodiment of the modular fire sprinkler apparatus 200 comprising a hexagonal main body 210, threaded ends 216, brackets 212, and a sprinkler 220. The main body 210 comprises an outer hexagonal shape and open-ended pipe 218 on the inside. The tee connector comprises three male threaded connectors 216, one inlet and two outlets, which connect to a female threaded fitting on a fire hose. The sprinkler 220 is shown in this exploded view to illustrate the means whereby the sprinkler connects to the main body 210. The tee connector modular fire sprinkler apparatus 200 further comprises three L-shaped brackets 212 with a vertical plane and horizontal plane. The vertical plane of the L-shaped brackets 212 attaches to an outside face of the main body 210. From this attachment, the vertical planes extends perpendicular away from the face of the main body 210. At a distance, the L-shaped bracket 212 bends at a right angle to form the horizontal plane of the L-shaped bracket 212. The horizontal plane further comprises a fastening hole 214 for inserting a fastener. The vertical plane of the L-shaped bracket 212 is tapered along the edge nearest to the sprinkler 220 to reduce obstruction to water spray distribution from the sprinkler.

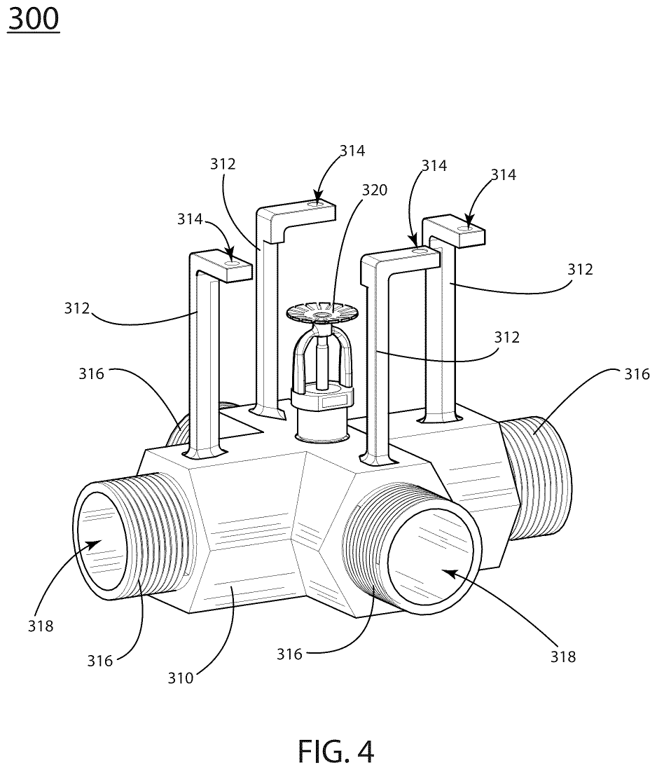

FIG. 4 illustrates a perspective view of a cross-connector embodiment of the modular fire sprinkler apparatus 300 comprising a hexagonal main body 310, threaded ends 316, brackets 312, and a sprinkler 320. The main body 310 comprises an outer hexagonal shape and open-ended pipe 318 on the inside. The cross-connector comprises four male threaded connectors 316, one inlet and three outlets, which connect to a female threaded fitting on a fire hose. The sprinkler 320 is shown in this exploded view to illustrate the means whereby the sprinkler 320 connects to the hexagonal main body 310. The modular fire sprinkler apparatus further comprises four L-shaped brackets 312 with a vertical plane and horizontal plane. The vertical plane of the L-shaped brackets 312 attaches to an outside face of the main body 310. From this attachment, the vertical planes extends perpendicular away from the face. At a distance, the L-shaped bracket 312 bends at a right angle to form the horizontal plane of the L-shaped bracket 312. The horizontal plane further comprises a fastening hole 314 for inserting a fastener. The vertical plane of the L-shaped bracket 312 is tapered along the edge nearest to the sprinkler head to reduce obstruction to water spray distribution from the sprinkler.

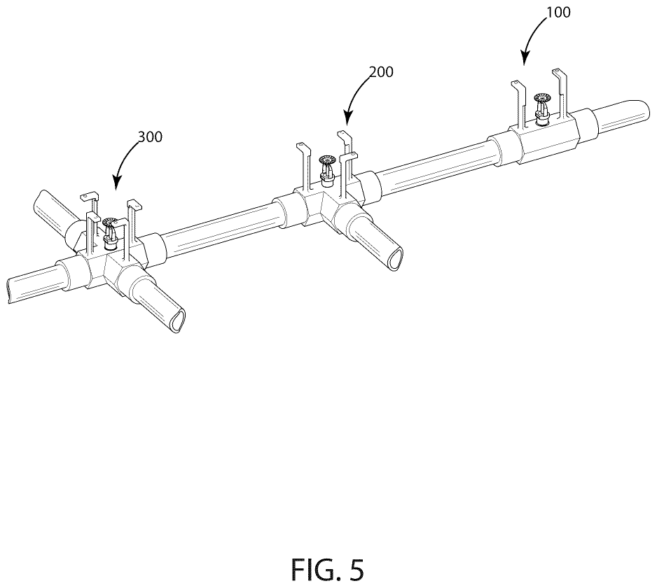

FIG. 5 is a perspective overview of the system for temporary installation of the modular fire sprinklers wherein a straight connector 100, tee connector 200, and cross-connector 300 are connected by fire hoses for illustrative purposes. A first fire hose connects to the inlet of the straight connector 100 as shown. A second fire hose connects the outlet of the straight connector 100 to the inlet of the tee connector 200 as shown. Further fire hoses connect the outlets of the tee connector 200 to the inlet of the cross connector 300 as shown. Fire hoses connect the outlets of the cross connector 300 to further modular fire sprinkler apparatuses or are capped. By means of these connections, the system is able to be set-up in multiple patterns, such as a straight line, loop, tree, or grid pattern, to provide sufficient fire coverage. Water is provided by a source which forces water through the hoses, modular fire sprinkler apparatuses, and out the sprinkler.

### System for Temporary Installation of Modular Fire Sprinklers

One purpose of the present invention is to provide a system for the temporary installation of modular fire sprinklers during initial construction, alteration, and reconstruction of large wood frames and other types of buildings to ensure the safety of workers, occupants, and protection of the building. The present invention is intended to be cost effective and efficient with ease of assembly, movement, relocation, and disassembly.

The system first comprises providing for a water source, in one aspect, city water or any suitable source with sufficient water for a sprinkler system. From the water source, pipes or hoses bring water to a building connector, such as, for example, a fire protection water service or standpipe riser with a wet pipe valve, dry pipe valve, or pre-action type sprinkler valve. Fire hoses are routed from the valve to a selected area of a building. The fire hose is connected to a modular fire sprinkler apparatus using either a straight connector, tee connector, or cross connector on an inlet threaded connector. An additional hose is connected to the outlet threaded connection of either the straight connector, tee connector, or cross connector. The modular fire sprinkler is attached to the ceiling via fastening holes in the bracket using a fastening means. This process is repeated until the selected area is properly covered by the system. The system may be set up in a straight line, loop, tree, grid, or other sufficient pattern. Depending upon the water supply valve type, the fire hose and the modular sprinkler apparatus may be filled with water or compressed air, supplied by the water supply valve. When heat rises to a predetermined temperature, the sprinkler on the modular sprinkler apparatus actuates, allowing water to flow through the fire hoses and modular sprinkler apparatuses until it reaches the modular sprinkler apparatus with the operated sprinkler head. Water is discharged from the sprinkler to suppress fire, flames, or to reduce temperature. If compressed air is used, such as in areas where water may freeze, compressed air is released from the hoses and modular sprinkler apparatuses. The hoses and modular sprinkler apparatuses are then filled with water once the water supply valve operates, eventually discharging water from the opened sprinkler head or heads. The modular sprinkler apparatus may further comprise a heat detector that may electronically actuate the water supply valve, which can help to prevent accidental discharge of water when a fire is not present. As required by the construction process and fire suppression needs, the system may be easily moved or relocated by removing the fastening means, disconnecting the fire hose, relocating the modular sprinkler apparatus, refastening, and reconnecting the fire hose. As required by the layout of the space, or the water supply conditions that are present, additional hoses and connectors may be employed to provide sufficient coverage or multiple pathways for water to reach an activated sprinkler or sprinklers. When the construction or alteration is complete and a permanent fire suppression system is installed, this system may be removed and used at a new construction site.

### Equivalents

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

All references, patents and patent applications disclosed herein are incorporated by reference with respect to the subject matter for which each is cited, which in some cases may encompass the entirety of the document.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than B); in another embodiment, to “B” only (optionally including elements other than A); in yet another embodiment, to both “A and B” (optionally including other elements); etc.

As used herein in the specification and in the claims, “or” should be understood to have the same meaning as “and/or” as defined above. For example, when separating items in a list, “or” or “and/or” shall be interpreted as being inclusive, e.g., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (e.g., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, e.g., to mean including but not limited to. Only the transitional phrases “consisting of” and “consisting essentially of” shall be closed or semi-closed transitional phrases, respectively. It should be appreciated that embodiments described in this document using an open-ended transitional phrase (e.g., “comprising”) are also contemplated, in alternative embodiments, as “consisting of” and “consisting essentially of” the feature described by the open-ended transitional phrase. For example, if the disclosure describes “a composition comprising A and B,” the disclosure also contemplates the alternative embodiments “a composition consisting of A and B” and “a composition consisting essentially of A and B.”

I claim:

1. A temporary fire protection system comprising:
a water source provided for to supply water to a location;
hoses to connect the water source to the modular sprinkler apparatus and to connect the modular sprinkler apparatus to other modular sprinkler apparatus; and
modular sprinkler apparatus at a location to provide temporary fire protection coverage of a building;
the modular sprinkler apparatus further comprising a main body, an inlet, an outlet, a threaded end, an open-ended pipe, L-shaped brackets, a fastening hole, and a sprinkler.

2. The system according to claim 1, wherein the water source is selected from one or more of the following: water tower, water tank, portable water supply, fire pump, city water, fire hydrant, standpipe, existing fire protection system, lake, pond, river, stream, ocean, or any other body of water suitable as a source.

3. The system according to claim 1, wherein the hose is any length, preferably 12 feet in length, and any diameter, preferably 2 inches in diameter with 1-½ inch nominal fire hose threads.

4. The modular sprinkler apparatus according to claim 1, wherein the modular sprinkler apparatus is selected from one or more of the following: straight connector modular sprinkler apparatus, tee connector modular sprinkler apparatus, and cross connector modular sprinkler apparatus.

5. The L-shaped brackets according to claim 1 wherein:
a vertical plane extends perpendicular a distance from a face of the main body, said vertical plane thereby bends at approximately a 90-degree angle forming a horizontal plane, said horizontal plane further comprising a hole for inserting a fastener as a means to attach the modular sprinkler apparatus to a ceiling.

6. The system according to claim 1, wherein the system is installed in a large wood frame or other building during initial construction, alteration, demolition, or reconstruction and other buildings which traditionally use sprinkler systems.

7. The system according to claim 1, wherein the system is modular or extendable by removing the fasteners from the brackets, moving the modular sprinkler apparatus to a different location, and reinstalling the fasteners in the brackets.

8. The system according to claim 1, wherein the water source is connected to a building, hoses are routed to specific locations in the building, the hoses are connected to the modular sprinkler apparatus, the modular sprinkler apparatus are attached to each other via hoses, the modular sprinkler apparatus are attached to the ceiling using fasteners through the brackets, the fire hoses are attached to the ceiling using brackets or hooks, and the system is organized in a pattern.

9. The system according to claim 1, wherein the pattern is a line, loop, tree, or grid.

10. The system according to claim 1, wherein a heat detector may be provided to electronically actuate a water supply valve.

11. A method of using the temporarily installed modular fire sprinklers, comprising the steps of:
providing for a water source, connecting the water source to a building, providing at the water supply a fire protection wet pipe valve, dry pipe valve, or pre-action valve, providing for hoses, routing hoses to specified locations inside the building, providing for modular sprinkler apparatus, attaching the hoses to the modular sprinkler apparatus, connecting multiple modular sprinklers using the hoses, attaching the modular sprinkler connectors to the ceiling of the building using brackets, and organizing the system in a pattern to provide fire suppression coverage to a building.

12. The method according to claim 11, wherein the water source is chosen from one of the following: water tower, water tank, portable water supply, fire pump, city water, fire hydrant, existing fire protection system, lake, pond, river, stream, ocean, or any other body of water suitable as a source.

13. The method according to claim 11, wherein the hose is any suitable length, preferably 12 feet in length, and any suitable diameter, preferably 2 inches and using 1-½ inches nominal fire hose threads.

14. The method according to claim 11, wherein the modular sprinkler apparatus is selected from one or more of the following: straight connector modular sprinkler apparatus, tee connector modular sprinkler apparatus, and cross connector modular sprinkler apparatus.

15. The L-shaped brackets according to claim 11 wherein:
a vertical plane extends perpendicular a distance from a face of the main body, said vertical plane thereby bends at approximately a 90-degree angle forming a horizontal plane, said horizontal plane further comprising a hole for inserting a fastener as a means to attach the modular sprinkler apparatus to a ceiling.

16. The method according to claim 11, wherein the system is installed in a large wood frame or other building during initial construction, alteration, or reconstruction and other buildings which traditionally use sprinkler systems.

17. The method according to claim 11, wherein the system is modular or extendable by disconnecting the fire hose from a modular sprinkler apparatus, removing the fasteners from the brackets, moving the modular sprinkler apparatus to a different location, reinstalling the fasteners in the brackets, and reconnecting the fire hose to the modular sprinkler apparatus.

18. The method according to claim 11, wherein the water source is connected to a building, hoses are routed to specific locations in the building, the hoses are connected to the modular sprinkler apparatus, the modular sprinkler apparatus are attached to each other via hoses, the modular sprinkler apparatus are attached to the ceiling using fasteners through the brackets, and the system is organized in a pattern.

19. The method according to claim 11, wherein the pattern is a line, loop, tree, or grid.

20. The method according to claim 11, wherein the method may further comprise providing a heat detector to electronically actuate a water supply valve.
